(19) United States
(12) Patent Application Publication
(10) Pub. No.: US 2018/0048726 A1
(43) Pub. Date: Feb. 15, 2018

(54) RECORDING AND RESTORING A CLICK POSITION IN A WEBPAGE

(71) Applicant: Alibaba Group Holding Limited, George Town, KY (US)

(72) Inventor: Liang Tian, Hangzhou (CN)

(73) Assignee: Alibaba Group Holding Limited, George Town (KY)

(21) Appl. No.: 15/797,698

(22) Filed: Oct. 30, 2017

Related U.S. Application Data
(63) Continuation of application No. PCT/CN2016/079813, filed on Apr. 21, 2016.

(30) Foreign Application Priority Data
May 5, 2015 (CN) 201510224908.5

(51) Int. Cl. H04L 29/08; G06F 3/0484

(52) U.S. Cl. CPC H04L 67/22; G06F 3/0484

(57) ABSTRACT

A webpage is divided into a plurality of operating regions, where each of the plurality of operating regions has a reference coordinate position. A reference operating region corresponding to a click operation. A relative coordinate of a click position is calculated with respect to a reference coordinate position of the reference operating region. The relative coordinate of the click position is recorded.

### CROSS REFERENCE TO RELATED APPLICATIONS

This application is a continuation of PCT Application No. PCT/CN2016/079813, filed on Apr. 21, 2016, which claims priority to Chinese Patent Application No. 201510224908.5, filed on May 5, 2015, and each application is incorporated by reference in its entirety.

### TECHNICAL FIELD

The present application relates to the field of computer technologies, and in particular, to recording and restoring a click position in a webpage.

### BACKGROUND

As Internet technologies develop and Internet resources become increasingly abundant, a user can acquire a larger amount of information from the Internet. Providers of Internet services also conduct and analyze user behaviors and network operations related to user access of Internet content (for example, webpages). For example, a user's preference for a webpage typographic style can be obtained by recording the user's click behaviors for webpages having the same content but different typographic designs. Also, a user's interest level for information content can be obtained by recording the user's click behaviors for different types of information in the webpages. Therefore, obtaining reliable data for user click behavior in webpages can be important for analyzing user behaviors and optimizing a designed system user experience.

### SUMMARY

The present disclosure describes recording and restoring a click position in a webpage.

In an implementation, a webpage is divided into a plurality of operating regions, where each of the plurality of operating regions has a reference coordinate position. A reference operating region corresponding to a click operation. A relative coordinate of a click position is calculated with respect to a reference coordinate position of the reference operating region. The relative coordinate of the click position is recorded.

Implementations of the described subject matter, including the previously described implementation, can be implemented using a computer-implemented method; a non-transitory, computer-readable medium storing computer-readable instructions to perform the computer-implemented method; and a computer-implemented system comprising one or more computer memory devices interoperably coupled with one or more computers and having tangible, non-transitory, machine-readable media storing instructions that, when executed by the one or more computers, perform the computer-implemented method/the computer-readable instructions stored on the non-transitory, computer-readable medium.

The subject matter described in this specification can be implemented in particular implementations, so as to realize one or more of the following advantages. First, this approach can provide flexibility in processing webpages having different alignments and formats. Second, this approach enables statistical analysis targeting individual operating regions in a webpage. Third, this approach support operations of dynamic webpages. Fourth, this approach enables analysis on comparisons between operating regions in a webpage. Other advantages will be apparent to those of ordinary skill in the art.

The details of one or more implementations of the subject matter of this specification are set forth in the Detailed Description, the Claims, and the accompanying drawings. Other features, aspects, and advantages of the subject matter will become apparent from the Detailed Description, the Claims, and the accompanying drawings.

### DESCRIPTION OF DRAWINGS

FIG. 1 is a schematic diagram illustrating an example of a webpage layout, according to an implementation of the present disclosure.

FIG. 2 is a schematic diagram illustrating another example of a webpage layout, according to an implementation of the present disclosure.

FIG. 3 is a flowchart illustrating an example of a method for recording a click position, according to an implementation of the present disclosure.

FIG. 4A illustrates an example of a webpage including a plurality of operating regions, according to an implementation of the present disclosure.

FIG. 4B illustrates another example of a webpage including a plurality of operating regions, according to an implementation of the present disclosure.

FIG. 5 illustrates an example of a DOM structure, according to an implementation of the present disclosure.

FIG. 6 illustrates an example of a click position determination, according to an implementation of the present disclosure.

FIG. 7 is a flowchart illustrating an example of a method for restoring a click position, according to an implementation of the present disclosure.

FIG. 8 illustrates an example of positions of operating regions, according to an implementation of the present disclosure.

FIG. 9 is a flowchart illustrating an example of a method for restoring a click position based on the size of an operating region, according to an implementation of the present disclosure.

FIG. 10 illustrates an example of a change of the size of an operating region, according to an implementation of the present disclosure.

FIG. 11 is a flowchart illustrating an example of a method for restoring a click position based on the disappearance of an operating region, according to an implementation of the present disclosure.

FIG. 12 illustrates an example of a disappearance of an operating region, according to an implementation of the present disclosure.

FIG. 13 is a schematic diagram illustrating an example of a computing device that records a click position as described in the present disclosure, according to an implementation of the present disclosure.

FIG. 14 is a schematic diagram illustrating an example of a computing device that restores a click position as described in the present disclosure, according to an implementation of the present disclosure.

FIG. 15 is a block diagram illustrating an example of a computer system used to provide computational functionalities associated with described algorithms, methods, functions, processes, flows, and procedures, according to an implementation of the present disclosure.

Like reference numbers and designations in the various drawings indicate like elements.

### DETAILED DESCRIPTION

The following detailed description describes recording and restoring a click position in a webpage, and is presented to enable any person skilled in the art to make and use the disclosed subject matter in the context of one or more particular implementations. Various modifications, alterations, and permutations of the disclosed implementations can be made and will be readily apparent to those or ordinary skill in the art, and the general principles defined can be applied to other implementations and applications, without departing from the scope of the present disclosure. In some instances, details unnecessary to obtain an understanding of the described subject matter can be omitted so as to not obscure one or more described implementations with unnecessary detail and inasmuch as such details are within the skill of one of ordinary skill in the art. The present disclosure is not intended to be limited to the described or illustrated implementations, but to be accorded the widest scope consistent with the described principles and features.

In some implementations, a user's click behaviors may be analyzed. For example, a webpage can be designed with different design schemes based on different structures, layouts, and styles. Webpages with these different design schemes can be distributed to one or more target users. The click behaviors of the target users can be analyzed to determine the popularity and effectiveness the respective design schemes. The analysis can be used to optimize the webpage.

To analyze the user's click behaviors, the click position, representing the position of the cursor on a webpage where a click operation is performed, can be recorded when the click operation is detected. The position of the click operation can be restored at a later moment when the analysis of the user's behavior is conducted.

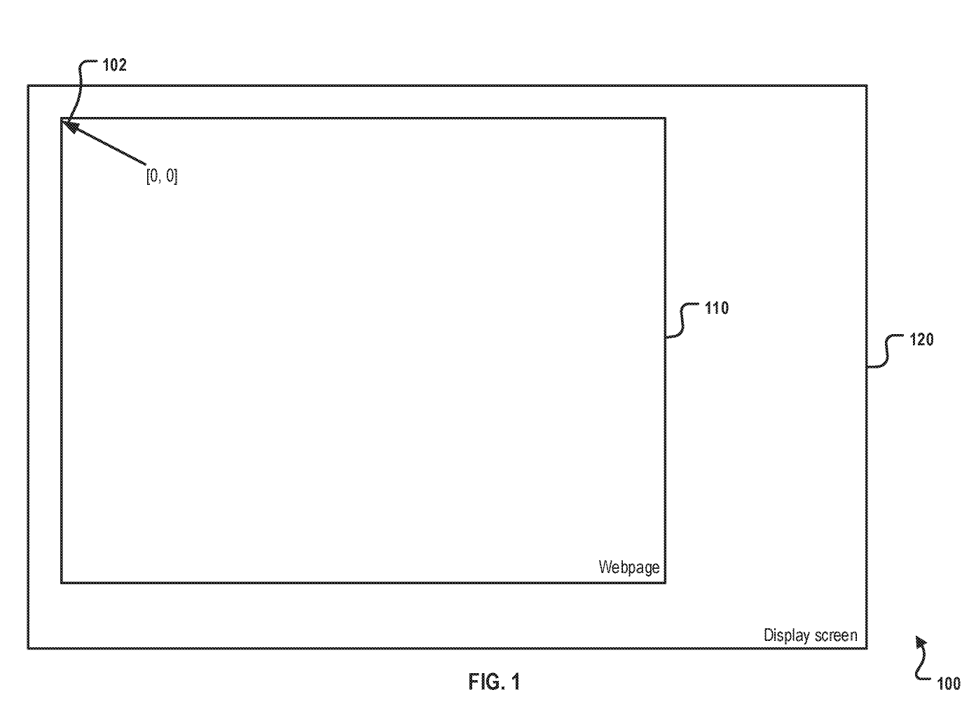

In some cases, static methods can be used to record a user's click behaviors in a webpage depending on the layout of the webpage. FIG. 1 is a schematic diagram 100 illustrating an example of a webpage layout, according to an implementation of the present disclosure. As illustrated, a webpage 110 is displayed on a display screen 120 of a computing device. The webpage 110 has a left alignment layout. In this example, coordinate 102, positioned at the upper left corner of the webpage 110, and having an [x, y] coordinate of [0, 0], is used as a reference coordinate to record click behaviors.

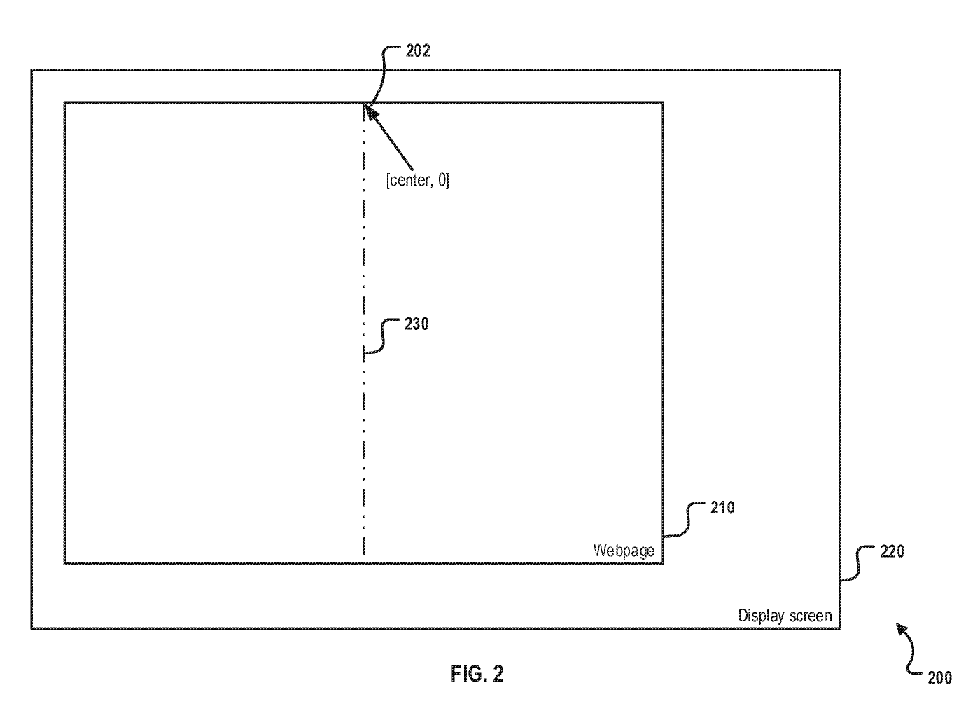

FIG. 2 is a schematic diagram 200 illustrating another example of a webpage layout, according to an implementation of the present disclosure. As illustrated, a webpage 210 is displayed on a display screen 220 of a computing device. The webpage 210 has a centered layout. In this example, coordinate 202, positioned at the top of a vertical central axis 230 of the webpage 210, and having an [x, y] coordinate of [center, 0], is used as a reference coordinate to record click behaviors.

However, these methods do not take into account the operations of a dynamic webpage. The webpage may be different between the time the click positions are recorded and the time of analysis. For example, some regions in the webpage may move, change size, or disappear due to user interactions.

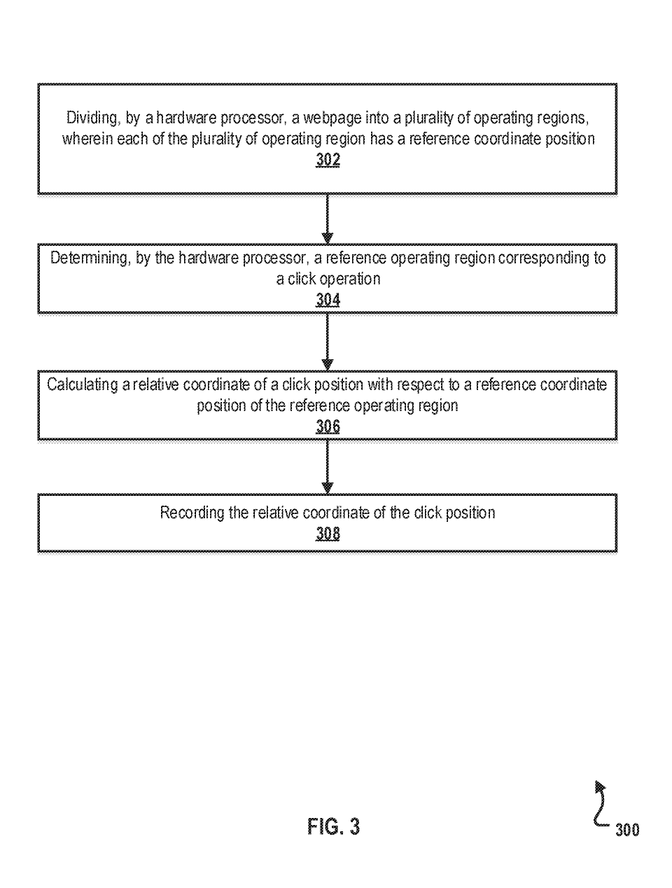

In some implementations, a relative coordinate of a click position can be recorded. The relative coordinate of the click position can be calculated based on a reference coordinate position of a reference operating region within the webpage. The relative coordinate can be used to restore the webpage for analysis at a later time. FIGS. 3-15 and associated descriptions provide additional details of these implementations.

FIG. 3 is a flowchart illustrating an example of a method 300 for recording a click position, according to an implementation of the present disclosure. For clarity of presentation, the description that follows generally describes method 300 in the context of the other figures in this description. However, it will be understood that method 300 can be performed, for example, by any system, environment, software, and hardware, or a combination of systems, environments, software, and hardware, as appropriate. In some implementations, various steps of method 300 can be run in parallel, in combination, in loops, or in any order.

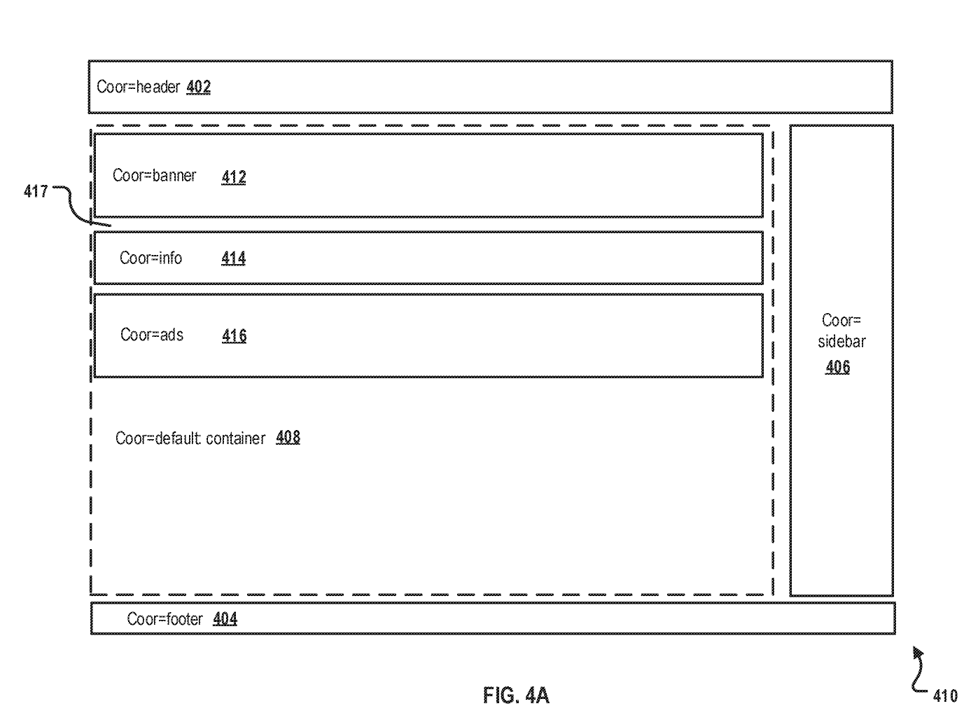

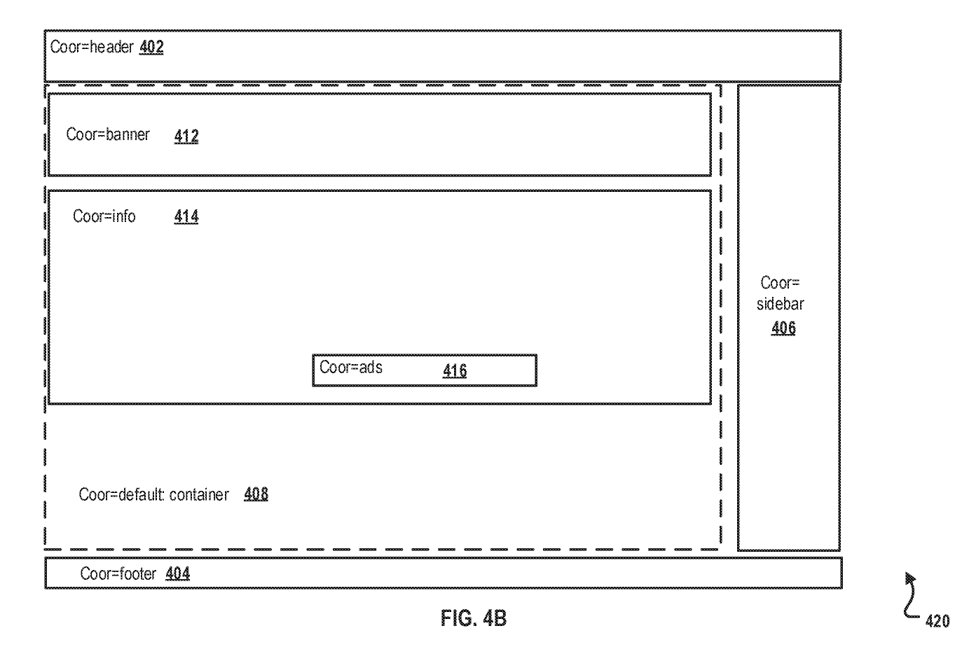

At 302, a webpage is divided into a plurality of operating regions. In some cases, the webpage can be divided based on the frame structure of the webpage, historical user behaviors of the webpage, or a combination thereof. FIG. 4A illustrates an example of a webpage 410 including a plurality of operating regions, according to an implementation of the present disclosure. As illustrated, the webpage includes a header region 402, a footer region 404, a sidebar region 406, a banner region 412, an info region 414, an ad region 416, and a container region 408. In one example, these regions are divided based on the frame structure of the webpage. The frame structure of the webpage may include components such as a header, a footer, and a sidebar, and, therefore, each component can be considered a separate operating region.

Alternatively or additionally, the operating regions can be divided based on historical user behaviors. In one example, if one operating region, for example the info region 414, has received user clicks that exceed a threshold number, the info region 414 can be further divided into multiple operating regions. In another example, if user behaviors indicate that clicks of two or more operating regions, for example the info region 414 and the adjacent ad region 416, are highly coordinated, these two regions can be combined into one operating region. In yet another example, if more than one region of the webpage, for example the header region 402 and the footer region 404, do not exceed a threshold number, these regions can be combined in one operating region. The historical user behaviors, including, for example, the number of user clicks and the correlation between user clicks, can be stored on the computing device that displays the webpage, on a server, or a combination thereof. The historical number of user clicks can be retrieved before the division of the operating regions.

In some cases, prior to dividing a webpage into operating regions, a reference region in the webpage is determined. The reference region may include regions that are likely to receive user clicks. In some cases, the reference region can be divided based on the frame structure of the webpage, historical user behaviors of the webpage, or a combination thereof. For example, a reference region for the webpage 410 may include the banner region 412, the info region 414, the ad region 416, and the sidebar region 406. On the other hand, margins and spaces on the webpage, may not receive many user clicks that would significantly impact the statistical analysis of user behaviors. These areas may not be included in the reference region. After determining the reference region, the reference region can be further divided into multiple operating regions. In some implementations, the operating regions can be divided directly from the webpage, without first determining an operating region.

In some cases, those regions that are not included in the reference region can be grouped into a container region. For example, as shown in FIG. 4A, the container region 408 can include margins and spaces in the webpage 410 that do not belong to any operating regions. The container region 408 can also include blank regions (for example, 417) between block elements, between inline elements, and between a block element and an inline element. Grouping these regions into one container region and sharing a reference coordinate position of the reference region can increase determinability of click coordinates for these regions.

In some cases, different operating regions can be adjacent to each other, as shown in FIG. 4A, or overlap with each other, as shown in FIG. 4B. FIG. 4B illustrates another example of a webpage 420 including a plurality of operating regions, according to an implementation of the present disclosure. As shown in FIG. 4B, the ad region 416 is nested into the info region 414. A range or boundary of each operating region may be determined according to the frame structure and the style of the webpage.

Returning to FIG. 3, from 302, method 300 proceeds to 304.

At 304, a reference operating region corresponding to a user click operation is determined. After a user performs a click operation in the webpage, the browser can obtain a Document Object Model (DOM) element (nestable) corresponding to the click operation of the user. Because the operating regions in the webpage are marked on the DOM element, a mark of an operating region can be searched for by layer-by-layer upward recursion. Once the mark of the operating region is found, the click position can be determined to be located in the corresponding operating region. Alternatively or additionally, after finding the mark of the operating region, the browser can also send information of the mark to a server, and the server can determine the operating region corresponding to the click operation of the user.

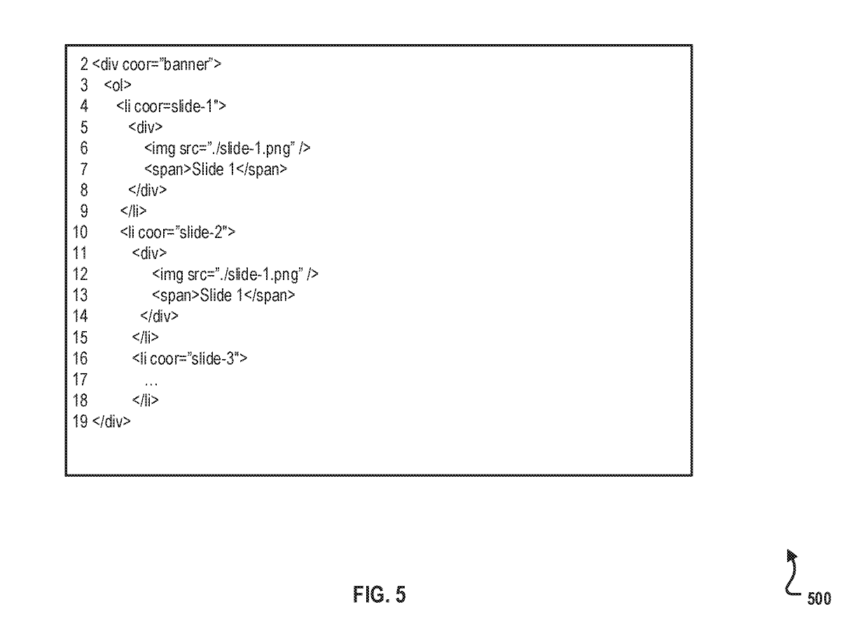

FIG. 5 illustrates an example of a DOM structure 500, according to an implementation of the present disclosure. The illustrated DOM structure 500 has a nested structure. If a user clicks the text of “Slide 1,” the browser or the server can traverse the nest structure and find an operating region that includes the node [li coor=“slide-1”] as the operating region where the user click is located.

Returning to FIG. 3, from 304, method 300 proceeds to 306, where the relative coordinate of the click position with respect to the reference coordinate position of the reference operating region is calculated. Each operating region has a reference coordinate. The reference coordinate can be determined based on the layout of the operating region. For example, the reference coordinate can be the upper left corner of the operating region if the operating region is left aligned. The reference coordinate can also be the top center of the operating region if the operating region is center aligned.

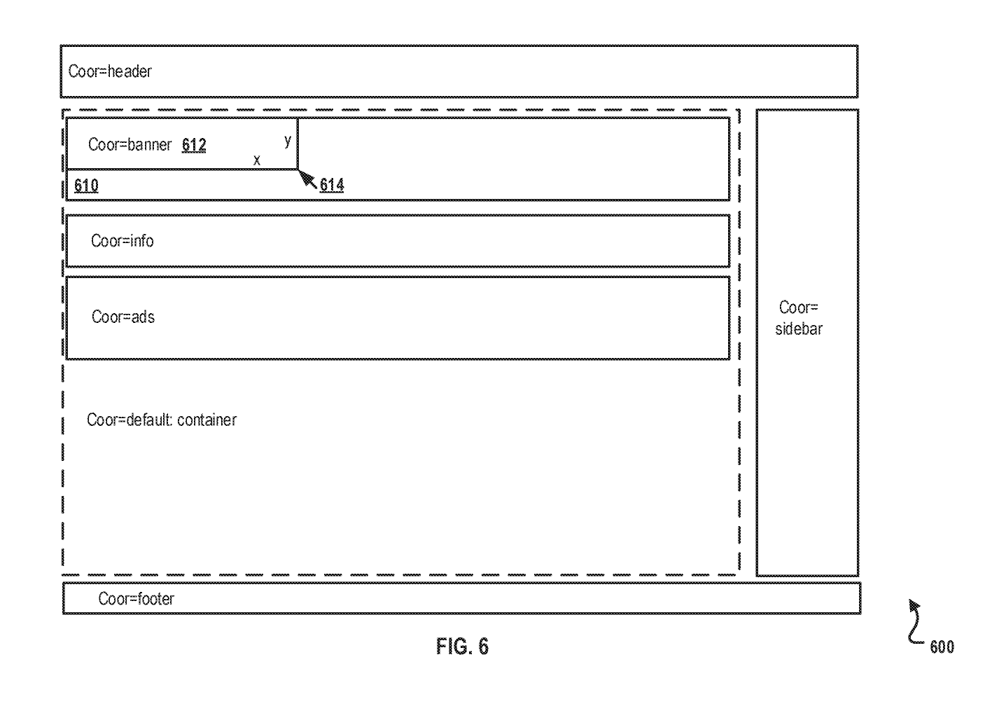

FIG. 6 illustrates an example of a click position determination 600, according to an implementation of the present disclosure. As illustrated, a click operation is determined to correspond to a banner region 610. The upper left corner of the banner region 610 is taken as a reference coordinate position 612, with an [x, y] coordinate of [0, 0]. The relative coordinate of the click position 614 is determined as an [x, y] value. The reference coordinate can be calculated by the browser, the server, or a combination thereof. In some cases, the relative coordinate can have a unit based on the number of pixels between the click position and the reference position. Returning to FIG. 3, from 306, method 300 proceeds to 308.

At 308, the click position is recorded. The recorded click position can include an indicator indicating the reference operating region and the relative coordinate of the click position with respect to the reference coordinate position. For example, the click position in FIG. 6 can be recorded as “banner: [x, y].”

In some cases, the relative coordinate of the click position can be stored in a server, for example, a web server such as an NGINX server. The NGINX server can also store an operating time of the click operation with the relative coordinates. The NGINX server uses less memory and has strong concurrent capability, and thus is suitable to store many user click positions. Other types of servers can also be used to store click position data. Alternatively or additionally, the browser on the computing device that displays the webpage can determine the operating time of the click operation, store the relative coordinate and the operating time, or a combination thereof. After 308, method 300 stops.

In some cases, method 300 can be implemented on a client terminal that displays the webpage and receives the user clicks. Alternatively or additionally, method 300 can be implemented on a server. In some implementations, the steps of method 300 can be implementated in more than one device. For example, steps 302 and 304 can be implemented on the client terminal that displays the webpage and receives the user click and steps 306 and 308 can be implemented on a server.

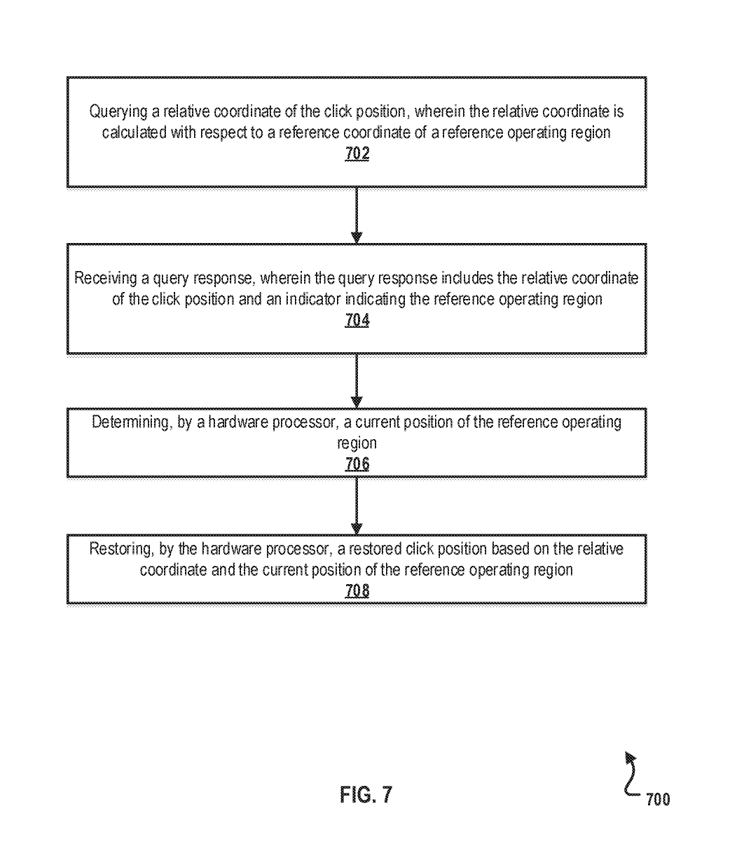

FIG. 7 is a flowchart illustrating an example of a method 700 for restoring a click position, according to an implementation of the present disclosure. For clarity of presentation, the description that follows generally describes method 700 in the context of the other figures in this description. However, it will be understood that method 700 can be performed, for example, by any system, environment, software, and hardware, or a combination of systems, environments, software, and hardware, as appropriate. In some implementations, various steps of method 700 can be run in parallel, in combination, in loops, or in any order.

At 702, a relative coordinate of a click position with respect to a reference coordinate of a reference operating region is queried. As discussed previously, the relative coordinate is recorded after the click operation is detected. The relative coordinate can be stored on the computing device where the webpage is displayed, or on a web server. Accordingly, the query is sent to the computing device, or the web server. From 702, the method 700 proceeds to 704.

At 704, a query response is received. The query response includes the relative coordinate of the click position and an indicator indicating the reference operating region corresponding to the click operation. From 704, the method 700 proceeds to 706.

At 706, a current position of the reference operating region in the webpage at a second moment is determined. The second moment can be a time of interest for analyzing the user behavior. In some cases, the operating time when the click operation took place can be referred to as the first moment, and the second moment can be a time between the first moment to the current time when the restoration takes place.

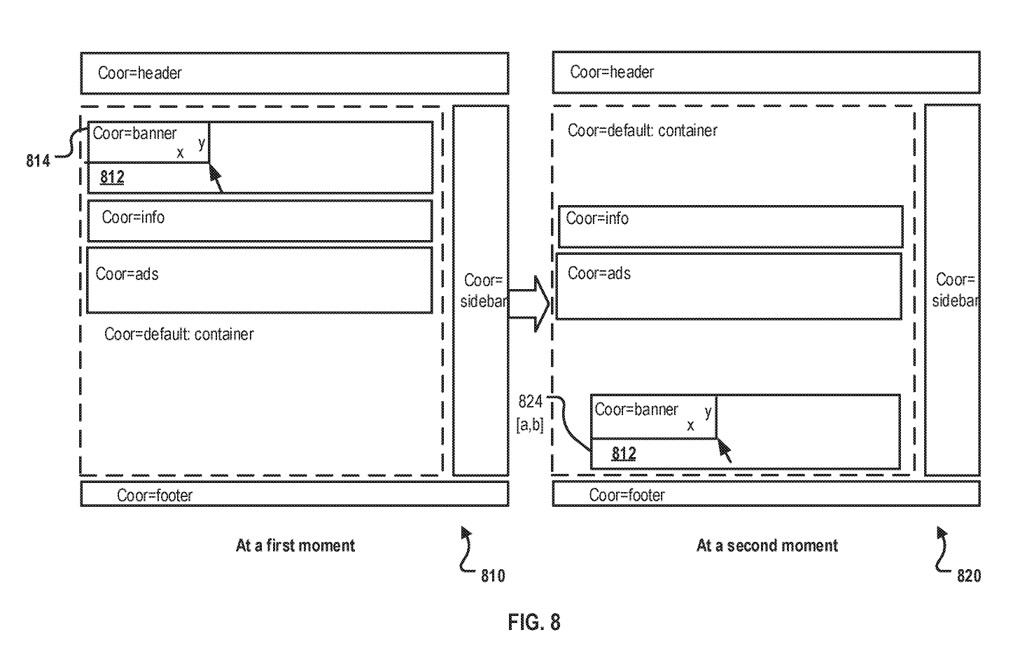

In some cases, the position of the operating region in a webpage at the second moment can be determined based on the reference coordinate of the operating region at the first moment. FIG. 8 illustrates an example of positions of operating regions, according to an implementation of the present disclosure. FIG. 8 includes a schematic diagram 810 of a webpage at the first moment and a schematic diagram 820 of the webpage at the second moment. At the first moment, the banner region 812 is at the top, and the upper left corner of the banner region 812 is located at a position 814. The position 814 is taken as the reference coordinate of the banner region 812, with a coordinate of [0, 0]. At the second moment, the banner region 812 has moved to the lower right portion of the webpage. The upper left corner of the banner region 812 has moved to a position 824, with a coordinate of [a, b] with respect to the reference coordinate [0, 0]. Accordingly, the position of the banner region 812 at the second moment can be determined to be [a, b]. Returning to FIG. 7, from 706, the method 700 proceeds to 708.

At 708, the click position of the click operation in the webpage is restored at the second moment. The click position can be restored according to the relative coordinate with respect to the reference coordinate position of the operating region, and the position of the operating region at the second moment. Referring back to FIG. 8, because the relative coordinate is [x, y] and the position of the banner region 812 at the second moment is [a, b], the restored position is [x+a, y+b]. The restored click position is used for data analysis at the second moment. This approach enables the analysis of user behaviors by taking account of the movement of the banner region. After 708, method 700 stops.

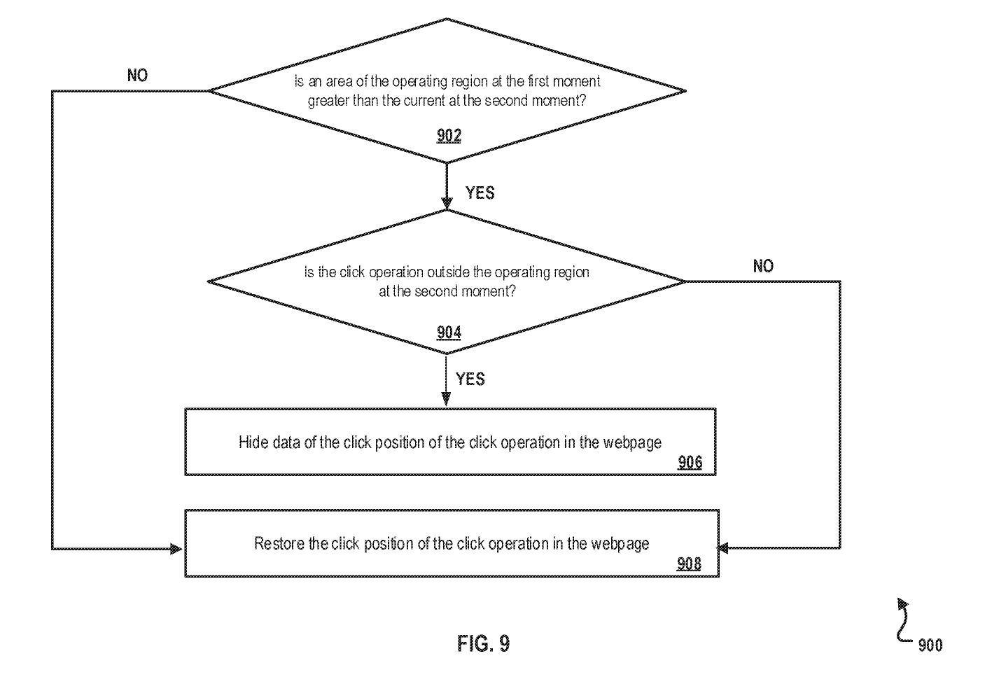

In some implementations, restoration can further take into account the size change of the operating regions. FIG. 9 is a flowchart illustrating an example of a method 900 for restoring a click position based on the size of an operating region, according to an implementation of the present disclosure. For clarity of presentation, the description that follows generally describes method 900 in the context of the other figures in this description. However, it will be understood that method 900 can be performed, for example, by any system, environment, software, and hardware, or a combination of systems, environments, software, and hardware, as appropriate. In some implementations, various steps of method 900 can be run in parallel, in combination, in loops, or in any order.

At 902, whether the area of the operating region at the first moment is greater than the area of the operating region at the second moment is determined. In some implementations, the area sizes at different moments are calculated in real-time. If the area of the operating region at the first moment is greater than the area of the operating region at the second moment, the method 900 proceeds from 902 to 904.

At 904, whether the click position is outside of the operating region at the second moment is determined. If the click position is outside of the operating region at the second moment, method 900 proceeds from 904 to 906, where the click position is hidden instead of being restored. If the click position of the area of the operating region at the first moment is less than or equal to the area of the operating region at the second moment, method 900 proceeds from 902 to 908. If the click position is not outside of the operating region at the second moment, method 900 proceeds from 904 to 908. At 908, the click position is restored.

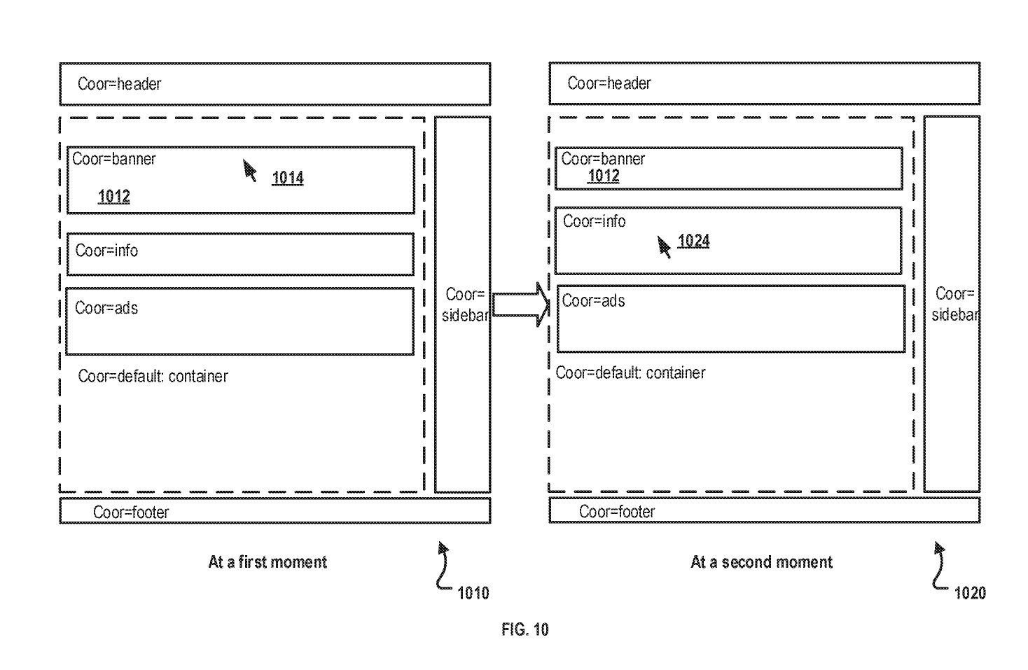

FIG. 10 illustrates an example of a change of the size of an operating region, according to an implementation of the present disclosure. FIG. 10 includes a schematic diagram 1010 of a webpage at the first moment and a schematic diagram 1020 of the webpage at the second moment. The size of the banner region 1012 is smaller at the second moment than the size of the banner region 1012 at the first moment. This may be due to a resize operation that takes place between the first moment and the second moment. The click position 1014 was inside the banner region 1012 at the first moment. However, the restored click position 1024 is located outside of the banner region 1012, because the size of the banner region 1012 has changed. In this case, the restored click position may be hidden from the restored webpage because the restored click position no longer reflects the user behavior correctly. The restored position can thus be removed from the analysis of the user behavior.

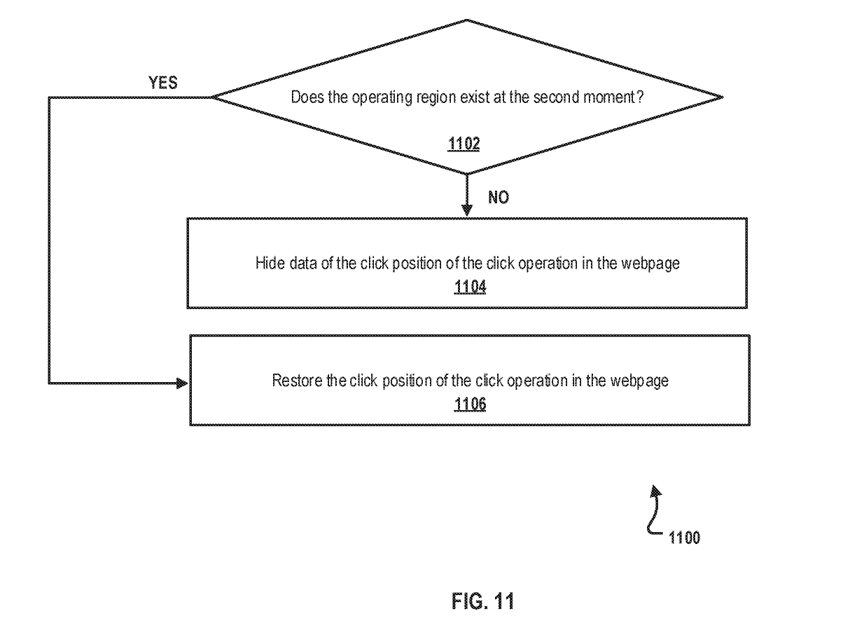

In some implementations, restoration can further take into account the disappearance of the operating regions. FIG. 11 is a flowchart illustrating an example of a method 1100 for restoring a click position based on the disappearance of an operating region, according to an implementation of the present disclosure. For clarity of presentation, the description that follows generally describes method 1100 in the context of the other figures in this description. However, it will be understood that method 1100 can be performed, for example, by any system, environment, software, and hardware, or a combination of systems, environments, software, and hardware, as appropriate. In some implementations, various steps of method 1100 can be run in parallel, in combination, in loops, or in any order.

At 1102, whether the operating region exists at the second moment is determined. If the area of the operating region at the second moment does not exist, the method 1100 proceeds from 1102 to 1104. If the operating region exists at the second moment, method 1100 proceeds from 1102 to 1106.

At 1104, the click position is hidden instead of being restored. After 1104, method 1100 stops.

At 1106, the click position is restored. After 1106, method 1100 stops.

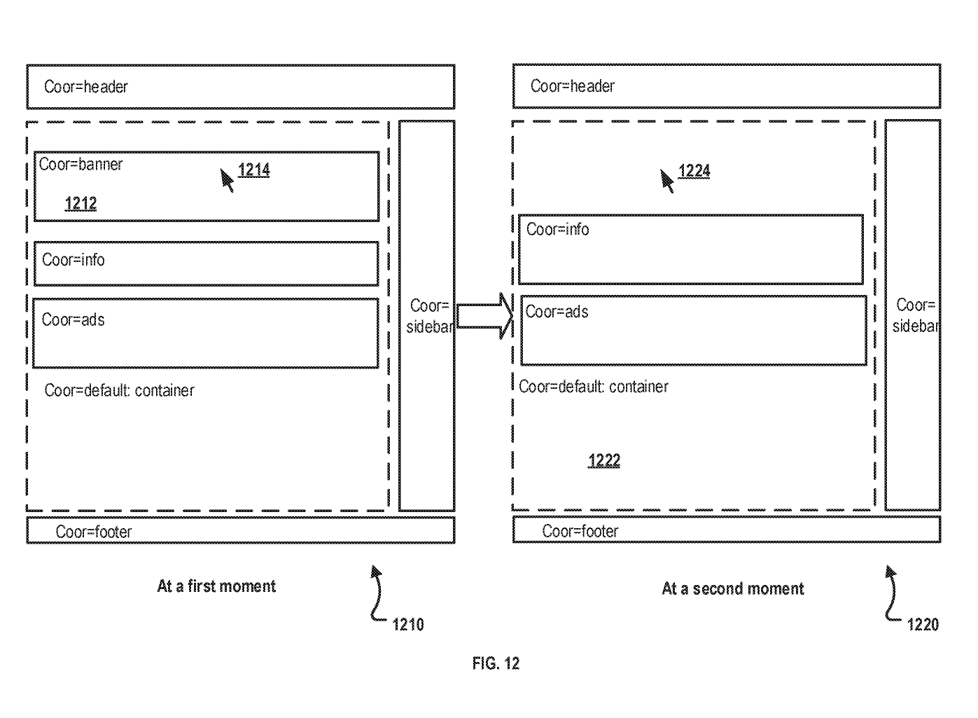

FIG. 12 illustrates an example of a disappearance of an operating region, according to an implementation of the present disclosure. FIG. 12 includes a schematic diagram 1210 of a webpage at the first moment and a schematic diagram 1220 of the webpage at the second moment. The banner region 1212 does not exist at the second moment. This may be due to a close operation of the banner region 1212 that takes place between the first moment and the second moment. The click position 1214 would have been restored at the restored position 1224, which would be inside the container region 1222. Therefore, the restored position 1224 can be hidden from the restoration of the webpage, and removed from the analysis because the restored position 1224 no longer correctly reflects the user behavior.

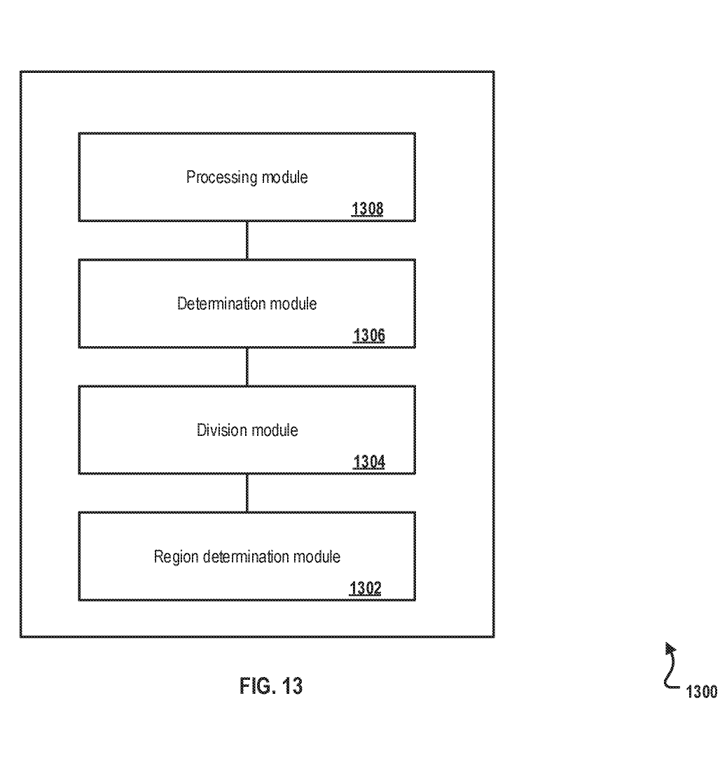

FIG. 13 is a schematic diagram illustrating an example of a computing device 1300 that records a click position as described in the present disclosure, according to an implementation of the present disclosure. The device 1300 includes a region determination module 1302, a division module 1304, a determination module 1306, and a processing module 1308.

The region determination module 1302 is configured to determine a reference region in a webpage in which a click position is to be recorded. The division module 1304 is configured to divide the reference region into several operating regions according to a frame structure and a style of the webpage. The division module 1304 is also configured to determine a region other than the reference region in the webpage as an operating region. The division module 1304 is also configured to determine at least one reference coordinate position for each operating region. The determination module 1306 is configured to determine a reference operating region where a click operation of a user is located. The processing module 1308 is configured to, by taking a reference coordinate position of the reference operating region where the click operation is located as a reference, calculate a relative coordinate of the position of the click operation with respect to the reference coordinate position, and record the relative coordinate as a click position of the click operation in the webpage.

In some implementations, the processing module 1308 is also configured to record the click position of the click operation in the webpage in a NGINX server; and the processing module 1308 is further configured to record an operating time of the click operation by using the NGINX server.

The computing device 1300 can be implementated on a server or on a client terminal that displays the webpage. In some implementations, the modules of the computing device 1300 can be implementated in more than one device. For example, the region determination module 1302, the division module 1304, and the determination module 1306 can be implemented on the client terminal that displays the webpage and receives the user click, and the processing module 1308 can be implemented on a server.

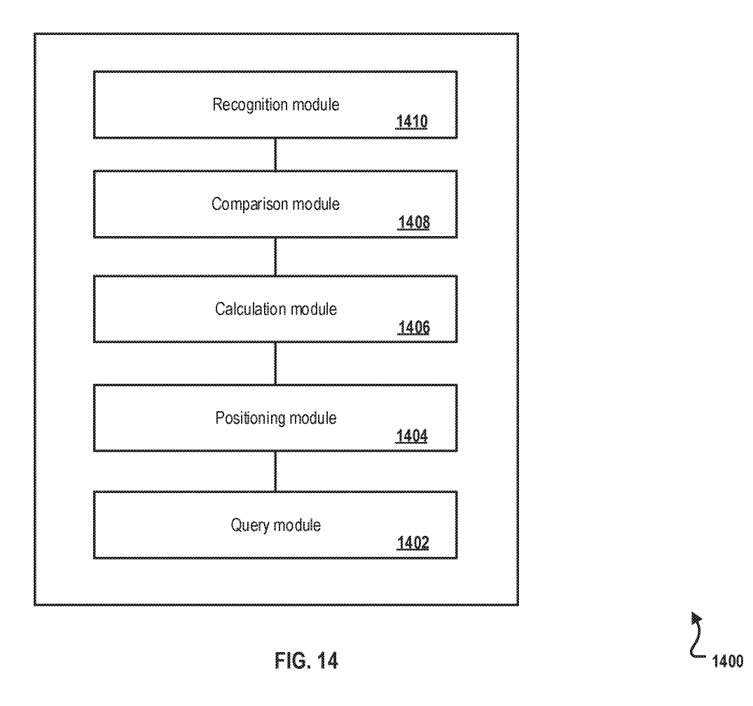

FIG. 14 is a schematic diagram illustrating an example of a computing device 1400 that restores a click position as described in the present disclosure, according to an implementation of the present disclosure. The device 1400 includes a query module 1402, a positioning module 1404, a calculation module 1406, a comparison module 1408, and a recognition module 1410.

The query module 1402 is configured to query the relative coordinate of a position of a click operation of a user with respect to a reference coordinate position of an operating region where the click operation is located. The relative coordinate is obtained at a first moment when the click position is recorded.

The positioning module 1404 is configured to determine a position of the operating region in the webpage at a second moment. The second moment represents the moment to be analyzed for user behavior analysis and the second moment occurs after the first moment.

The calculation module 1406 is configured to restore, at the second moment, a click position of the click operation in the webpage according to the relative coordinate of the position of the click operation with respect to the reference coordinate position of the operating region at the first moment and the position of the operating region in the webpage at the second moment.

The comparison module 1408 is configured to determine whether an area of the operating region at the first moment is greater than the area of the operating region at the second moment. The comparison module 1408 is further configured to determine whether the click operation is outside the operating region at the second moment. If the area of the operating region at the first moment is greater than the area of the operating region at the second moment and the click operation is outside the operating region at the second moment, the comparison module 1408 is configured to hide data of the click position in the webpage.

The recognition module 1410 is configured to determine whether the operating region exists at the second moment. If the operating region does not exist at the second moment, the recognition module 1410 is configured to hide data of the click position in the webpage.

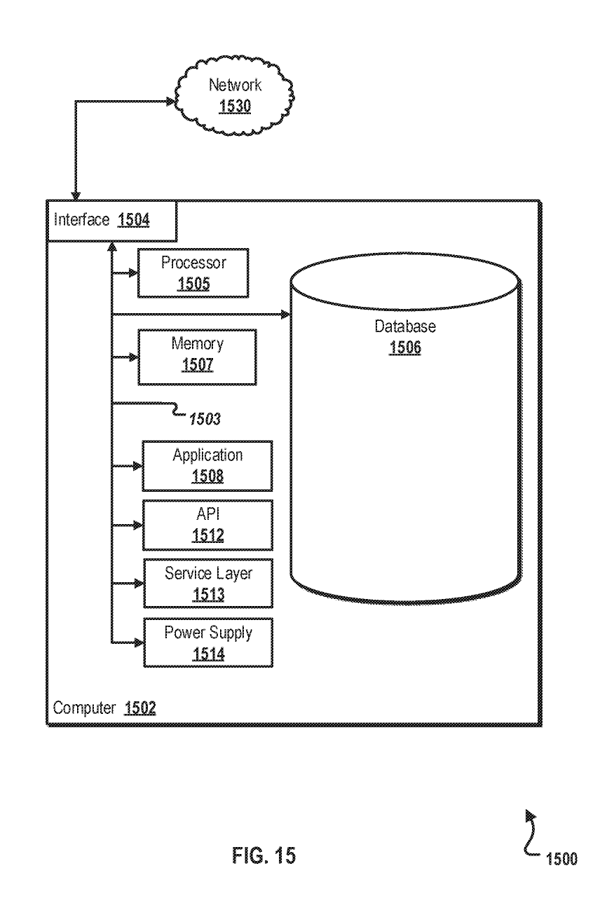

FIG. 15 is a block diagram illustrating an example of a computer system 1500 used to provide computational functionalities associated with described algorithms, methods, functions, processes, flows, and procedures, according to an implementation of the present disclosure. The illustrated computer 1502 is intended to encompass any computing device such as a server, desktop computer, laptop/notebook computer, wireless data port, smart phone, personal data assistant (PDA), tablet computing device, one or more processors within these devices, another computing device, or a combination of computing devices, including physical or virtual instances of the computing device, or a combination of physical or virtual instances of the computing device. Additionally, the computer 1502 can comprise a computer that includes an input device, such as a keypad, keyboard, touch screen, another input device, or a combination of input devices that can accept user information, and an output device that conveys information associated with the operation of the computer 1502, including digital data, visual, audio, another type of information, or a combination of types of information, on a graphical-type user interface (UI) (or GUI) or other UI. The computer 1502 can be used to implement the computing device that displays the webpage, detect the user click operation, and calculate the relative coordinate, as described previously. The computer 1502 can also be used to retrieve and restore the click position as described previously. The computer 1502 can also be used to implement a web server, for example, the NGINX server that records the relative coordinate of the click position.

The computer 1502 can serve in a role in a computer system as a client, network component, a server, a database or another persistency, another role, or a combination of roles for performing the subject matter described in the present disclosure. The illustrated computer 1502 is communicably coupled with a network 1530. In some implementations, one or more components of the computer 1502 can be configured to operate within an environment, including cloud-computing-based, local, global, another environment, or a combination of environments.

At a high level, the computer 1502 is an electronic computing device operable to receive, transmit, process, store, or manage data and information associated with the described subject matter. According to some implementations, the computer 1502 can also include or be communicably coupled with a server, including an application server, e-mail server, web server, caching server, streaming data server, another server, or a combination of servers.

The computer 1502 can receive requests over network 1530 (for example, from a client software application executing on another computer 1502) and respond to the received requests by processing the received requests using a software application or a combination of software applications. In addition, requests can also be sent to the computer 1502 from internal users (for example, from a command console or by another internal access method), external or third-parties, or other entities, individuals, systems, or computers.

Each of the components of the computer 1502 can communicate using a system bus 1503. In some implementations, any or all of the components of the computer 1502, including hardware, software, or a combination of hardware and software, can interface over the system bus 1503 using an application programming interface (API) 1512, a service layer 1513, or a combination of the API 1512 and service layer 1513. The API 1512 can include specifications for routines, data structures, and object classes. The API 1512 can be either computer-language independent or dependent and refer to a complete interface, a single function, or even a set of APIs. The service layer 1513 provides software services to the computer 1502 or other components (whether illustrated or not) that are communicably coupled to the computer 1502. The functionality of the computer 1502 can be accessible for all service consumers using this service layer. Software services, such as those provided by the service layer 1513, provide reusable, defined functionalities through a defined interface. For example, the interface can be software written in JAVA, C++, another computing language, or a combination of computing languages providing data in extensible markup language (XML) format, another format, or a combination of formats. While illustrated as an integrated component of the computer 1502, alternative implementations can illustrate the API 1512 or the service layer 1513 as stand-alone components in relation to other components of the computer 1502 or other components (whether illustrated or not) that are communicably coupled to the computer 1502. Moreover, any or all parts of the API 1512 or the service layer 1513 can be implemented as a child or a sub-module of another software module, enterprise application, or hardware module without departing from the scope of the present disclosure.

The computer 1502 includes an interface 1504. Although illustrated as a single interface 1504 in FIG. 15, two or more interfaces 1504 can be used according to particular needs, desires, or particular implementations of the computer 1502. The interface 1504 is used by the computer 1502 for communicating with another computing system (whether illustrated or not) that is communicatively linked to the network 1530 in a distributed environment. Generally, the interface 1504 is operable to communicate with the network 1530 and comprises logic encoded in software, hardware, or a combination of software and hardware. More specifically, the interface 1504 can comprise software supporting one or more communication protocols associated with communications such that the network 1530 or interface's hardware is operable to communicate physical signals within and outside of the illustrated computer 1502.

The computer 1502 includes a processor 1505. Although illustrated as a single processor 1505 in FIG. 15, two or more processors can be used according to particular needs, desires, or particular implementations of the computer 1502. Generally, the processor 1505 executes instructions and manipulates data to perform the operations of the computer 1502 and any algorithms, methods, functions, processes, flows, and procedures as described in the present disclosure.

The computer 1502 also includes a database 1506 that can hold data for the computer 1502, another component communicatively linked to the network 1530 (whether illustrated or not), or a combination of the computer 1502 and another component. For example, database 1506 can be an in-memory, conventional, or another type of database storing data consistent with the present disclosure. In some implementations, database 1506 can be a combination of two or more different database types (for example, a hybrid in-memory and conventional database) according to particular needs, desires, or particular implementations of the computer 1502 and the described functionality. Although illustrated as a single database 1506 in FIG. 15, two or more databases of similar or differing types can be used according to particular needs, desires, or particular implementations of the computer 1502 and the described functionality. While database 1506 is illustrated as an integral component of the computer 1502, in alternative implementations, database 1506 can be external to the computer 1502.

The computer 1502 also includes a memory 1507 that can hold data for the computer 1502, another component or components communicatively linked to the network 1530 (whether illustrated or not), or a combination of the computer 1502 and another component. Memory 1507 can store any data consistent with the present disclosure. In some implementations, memory 1507 can be a combination of two or more different types of memory (for example, a combination of semiconductor and magnetic storage) according to particular needs, desires, or particular implementations of the computer 1502 and the described functionality. Although illustrated as a single memory 1507 in FIG. 15, two or more memories 1507 or similar or differing types can be used according to particular needs, desires, or particular implementations of the computer 1502 and the described functionality. While memory 1507 is illustrated as an integral component of the computer 1502, in alternative implementations, memory 1507 can be external to the computer 1502.

The application 1508 is an algorithmic software engine providing functionality according to particular needs, desires, or particular implementations of the computer 1502, particularly with respect to functionality described in the present disclosure. For example, application 1508 can serve as one or more components, modules, or applications. Further, although illustrated as a single application 1508, the application 1508 can be implemented as multiple applications 1508 on the computer 1502. In addition, although illustrated as integral to the computer 1502, in alternative implementations, the application 1508 can be external to the computer 1502.

The computer 1502 can also include a power supply 1514. The power supply 1514 can include a rechargeable or non-rechargeable battery that can be configured to be either user- or non-user-replaceable. In some implementations, the power supply 1514 can include power-conversion or management circuits (including recharging, standby, or another power management functionality). In some implementations, the power-supply 1514 can include a power plug to allow the computer 1502 to be plugged into a wall socket or another power source to, for example, power the computer 1502 or recharge a rechargeable battery.

There can be any number of computers 1502 associated with, or external to, a computer system containing computer 1502, each computer 1502 communicating over network 1530. Further, the term “client,” “user,” or other appropriate terminology can be used interchangeably, as appropriate, without departing from the scope of the present disclosure. Moreover, the present disclosure contemplates that many users can use one computer 1502, or that one user can use multiple computers 1502.

Described implementations of the subject matter can include one or more features, alone or in combination.

For example, in a first implementation, one computer-implemented method for recording a click position includes: dividing, by a hardware processor, a webpage into a plurality of operating regions, wherein each of the plurality of operating regions has a reference coordinate position; determining, by the hardware processor, a reference operating region corresponding to a click operation; calculating, a relative coordinate of a click position with respect to a reference coordinate position of the reference operating region; and recording the relative coordinate of the click position.

The foregoing and other described implementations can each, optionally, include one or more of the following features:

A first feature, combinable with any of the following features, wherein dividing the webpage into the plurality of operating regions comprises: determining a reference region in the webpage based on at least one of a frame structure or historical user behaviors of the webpage; and dividing the reference region into the plurality of operating regions.

A second feature, combinable with any of the previous or following features, wherein the plurality of operating regions is divided based on a frame structure of the webpage.

A third feature, combinable with any of the previous or following features, wherein the plurality of operating regions is divided based on historical user behaviors of the webpage.

A fourth feature, combinable with any of the previous or following features, the method further comprising recording an indicator that indicates the reference operating region with the relative coordinate.

A fifth feature, combinable with any of the previous or following features, the method further comprising recording an operating time corresponding to the click operation.

A sixth feature, combinable with any of the previous or following features, wherein the plurality of operating regions comprises at least one of a header region, a banner region, an info region, an ad region, a footer region, or a sidebar region.

A seventh feature, combinable with any of the previous or following features, wherein the relative coordinate is recorded at a NGINX server.

In a second implementation, one computer-implemented method for restoring a click position includes: querying a relative coordinate of the click position, wherein the relative coordinate is calculated with respect to a reference coordinate of a reference operating region; receiving a query response, wherein the query response includes the relative coordinate of the click position and an indicator indicating the reference operating region; determining, by a hardware processor, a current position of the reference operating region; and restoring, by the hardware processor, a restored click position based on the relative coordinate and the current position of the reference operating region.

The foregoing and other described implementations can each, optionally, include one or more of the following features:

A first feature, combinable with any of the following features, wherein restoring the restored click position comprises: determining whether a size of the reference operating region has changed between a first moment corresponding to a click operation and a second moment that is different than the first moment; and wherein the restored click position is restored based on determining whether the size of the reference operating region has changed between the first moment and the second moment.

A second feature, combinable with any of the previous or following features, the method further comprising; determining whether the restored click position is outside of the reference operating region; and wherein the restored click position is restored based on the determining that the restored click position is not outside of the reference operating region.

A third feature, combinable with any of the previous or following features, wherein restoring the restored click position comprises: determining the reference operating region exists at a second moment that is different than a first moment that corresponds to the click operation; and wherein the restored click position is restored based on determining that the reference operating region exists at the second moment.

In a third implementation, a non-transitory, computer-readable medium storing computer-readable instructions, the instructions executable by a computer and configured to: divide a webpage into a plurality of operating regions, wherein each of the plurality of operating regions has a reference coordinate position; determine a reference operating region corresponding to a click operation; calculate, a relative coordinate of a click position with respect to a reference coordinate position of the reference operating region; and record the relative coordinate of the click position.

The foregoing and other described implementations can each, optionally, include one or more of the following features:

A first feature, combinable with any of the following features, wherein dividing the webpage into the plurality of operating regions comprises: determining a reference region in the webpage based on at least one of a frame structure or historical user behaviors of the webpage; and dividing the reference region into the plurality of operating regions.

A second feature, combinable with any of the previous or following features, wherein the plurality of operating regions is divided based on a frame structure of the webpage.

A third feature, combinable with any of the previous or following features, wherein the plurality of operating regions is divided based on historical user behaviors of the webpage.

A fourth feature, combinable with any of the previous or following features, the instructions further configured to record an indicator that indicates the reference operating region with the relative coordinate.

A fifth feature, combinable with any of the previous or following features, the instructions further configured to record an operating time corresponding to the click operation.

A sixth feature, combinable with any of the previous or following features, wherein the plurality of operating regions comprises at least one of a header region, a banner region, an info region, an ad region, a footer region, or a sidebar region.

A seventh feature, combinable with any of the previous or following features, wherein the relative coordinate is recorded at a NGINX server.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal, for example, a machine-generated electrical, optical, or electromagnetic signal that is generated to encode information for transmission to a receiver apparatus for execution by a data processing apparatus. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second (s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” or “electronic computer device” (or equivalent as understood by one of ordinary skill in the art) refer to data processing hardware and encompass all kinds of apparatus, devices, and machines for processing data, including by way of example, a programmable processor, a computer, or multiple processors or computers. The apparatus can also be, or further include special purpose logic circuitry, for example, a central processing unit (CPU), an FPGA (field programmable gate array), or an ASIC (application-specific integrated circuit). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with an operating system of some type, for example LINUX, UNIX, WINDOWS, MAC OS, ANDROID, IOS, another operating system, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and apparatus can also be implemented as, special purpose logic circuitry, for example, a CPU, an FPGA, or an ASIC.

Computers for the execution of a computer program can be based on general or special purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device.

Non-transitory computer-readable media for storing computer program instructions and data can include all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital video disc (DVD), CD-ROM, DVD+/−R, DVD-RAM, DVD-ROM, HD-DVD, and BLURAY, and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special purpose logic circuitry.

To provide for interaction with a user, implementations of the subject matter described in this specification can be implemented on a computer having a display device, for example, a CRT (cathode ray tube), LCD (liquid crystal display), LED (Light Emitting Diode), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity, a multi-touch screen using capacitive or electric sensing, or another type of touchscreen. Other types of devices can be used to interact with the user. For example, feedback provided to the user can be any form of sensory feedback (such as, visual, auditory, tactile, or a combination of feedback types). Input from the user can be received in any form, including acoustic, speech, or tactile input. In addition, a computer can interact with the user by sending documents to and receiving documents from a client computing device that is used by the user (for example, by sending web pages to a web browser on a user's mobile computing device in response to requests received from the web browser).

The term “graphical user interface,” or “GUI,” can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n or 802.20 (or a combination of 802.11x and 802.20 or other protocols consistent with the present disclosure), all or a portion of the Internet, another communication network, or a combination of communication networks. The communication network can communicate with, for example, Internet Protocol (IP) packets, Frame Relay frames, Asynchronous Transfer Mode (ATM) cells, voice, video, data, or other information between network nodes.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or on the scope of what can be claimed, but rather as descriptions of features that can be specific to particular implementations of particular inventions. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method for recording a click position, comprising:
dividing, by a hardware processor, a webpage into a plurality of operating regions, wherein each of the plurality of operating regions has a reference coordinate position;
determining, by the hardware processor, a reference operating region corresponding to a click operation;
calculating, a relative coordinate of a click position with respect to a reference coordinate position of the reference operating region; and
recording the relative coordinate of the click position.

2. The method of claim 1, wherein dividing the webpage into the plurality of operating regions comprises:
determining a reference region in the webpage based on at least one of a frame structure or historical user behaviors of the webpage; and
dividing the reference region into the plurality of operating regions.

3. The method of claim 1, wherein the plurality of operating regions is divided based on a frame structure of the webpage.

4. The method of claim 1, wherein the plurality of operating regions is divided based on historical user behaviors of the webpage.

5. The method of claim 1, further comprising recording an indicator that indicates the reference operating region with the relative coordinate.

6. The method of claim 1, further comprising recording an operating time corresponding to the click operation.

7. The method of claim 1, wherein the plurality of operating regions comprises at least one of a header region, a banner region, an info region, an ad region, a footer region, or a sidebar region.

8. The method of claim 1, wherein the relative coordinate is recorded at a NGINX server.

9. A computer-implemented method for restoring a click position, comprising:
querying a relative coordinate of the click position, wherein the relative coordinate is calculated with respect to a reference coordinate of a reference operating region;
receiving a query response, wherein the query response includes the relative coordinate of the click position and an indicator indicating the reference operating region;
determining, by a hardware processor, a current position of the reference operating region; and
restoring, by the hardware processor, a restored click position based on the relative coordinate and the current position of the reference operating region.

10. The method of claim 9, wherein restoring the restored click position comprises:
determining whether a size of the reference operating region has changed between a first moment corresponding to a click operation and a second moment that is different than the first moment; and
wherein the restored click position is restored based on determining whether the size of the reference operating region has changed between the first moment and the second moment.

11. The method of claim 10, further comprising;
determining whether the restored click position is outside of the reference operating region; and
wherein the restored click position is restored based on the determining that the restored click position is not outside of the reference operating region.

12. The method of claim 9, wherein restoring the restored click position comprises:
determining the reference operating region exists at a second moment that is different than a first moment that corresponds to the click operation; and
wherein the restored click position is restored based on determining that the reference operating region exists at the second moment.

13. A non-transitory, computer-readable medium storing computer-readable instructions, the instructions executable by a computer and configured to:
divide a webpage into a plurality of operating regions, wherein each of the plurality of operating regions has a reference coordinate position;
determine a reference operating region corresponding to a click operation;
calculate, a relative coordinate of a click position with respect to a reference coordinate position of the reference operating region; and
record the relative coordinate of the click position.

14. The non-transitory, computer-readable medium of claim 13, wherein dividing the webpage into the plurality of operating regions comprises:
determining a reference region in the webpage based on at least one of a frame structure or historical user behaviors of the webpage; and
dividing the reference region into the plurality of operating regions.

15. The non-transitory, computer-readable medium of claim 13, wherein the plurality of operating regions is divided based on a frame structure of the webpage.

16. The non-transitory, computer-readable medium of claim 13, wherein the plurality of operating regions is divided based on historical user behaviors of the webpage.

17. The non-transitory, computer-readable medium of claim 13, the instructions further configured to record an indicator that indicates the reference operating region with the relative coordinate.

18. The non-transitory, computer-readable medium of claim 13, the instructions further configured to record an operating time corresponding to the click operation.

19. The non-transitory, computer-readable medium of claim 13, wherein the plurality of operating regions comprises at least one of a header region, a banner region, an info region, an ad region, a footer region, or a sidebar region.

20. The non-transitory, computer-readable medium of claim 13, wherein the relative coordinate is recorded at a NGINX server.
